(19) United States
(12) Patent Application Publication
(10) Pub. No.: US 2026/0326227 A1
(43) Pub. Date: Oct. 22, 2026

(54) TORCH CONSUMABLE ANALYSIS

(71) Applicant: The ESAB Group, Inc., North Bethesda, MD (US)

(72) Inventors: Erik Anthony Leger, Newmarket, NH (US); Secundino Miguel Baldonado, Hopkinton, NH (US)

(21) Appl. No.: 19/468,340

(22) Filed: Feb. 3, 2026

Related U.S. Application Data
(63) Continuation of application No. PCT/US2024/041068, filed on Aug. 6, 2024.
(60) Provisional application No. 63/518,381, filed on Aug. 9, 2023.

(51) Int. Cl. B23K 9/095; B23K 9/24

(52) U.S. Cl. CPC B23K 9/0953; B23K 9/24

(57) ABSTRACT

A non-transitory computer-readable medium includes instructions that, when executed by a processor, are configured to cause the processor to perform operations that include determining a plurality of properties of a vibration signal resulting from a gas flow being directed through a consumable assembly of a torch system over a period of time, generating a vibration profile of the consumable assembly based on the plurality of properties, and determining a type of the consumable assembly based on the vibration profile. One or more parameters of the gas flow directed through the consumable assembly are adjusted over the period of time to cause the vibration signal to have the plurality of properties.

### CROSS-REFERENCE

This application claims priority to and the benefit of International Patent Application No. PCT/US2024/041068, entitled “TORCH CONSUMABLE ANALYSIS”, filed on Aug. 6, 2024, which claims priority to and the benefit of U.S. Provisional Patent Application No. 63/518,381, entitled “TORCH CONSUMABLE ANALYSIS,” filed Aug. 9, 2023, the entire disclosures of which are hereby incorporated by reference in their entirety for all purposes.

### TECHNICAL FIELD

The present disclosure is directed toward welding and/or cutting torches and, in particular, to methods of determining a type of a consumable or consumable assembly of a welding and/or cutting torch based on a vibration profile.

### BACKGROUND OF THE INVENTION

A torch, such as a cutting torch or a welding torch, is used to perform various operations with respect to a metal workpiece. For example, the torch may be used to remove material from the metal workpiece for a cutting operation or to melt material for a welding operation. In either case, the torch includes a torch body and at least one consumable component (e.g., in addition to consumable wire).

The torch body is configured to couple to a power supply, and the consumable is configured to couple to the torch body. The power supply is configured to direct a gas flow to the torch body, which directs the gas flow to the consumable so that the gas flow can be utilized during the cutting or welding operation (e.g., to generate plasma, shield a weld or arc). In some embodiments, different types or embodiments of consumables can be coupled to the torch body, e.g., to operate at different amperages or in different modes (e.g., cutting, gouging). The respective types of consumables may be configured to operate more effectively (e.g., efficiently) at different operational parameters, such as electric power and/or gas flow rates. Thus, it is desirable to be able to identify the type of consumable attached to the torch body to establish the operational parameters that enable desirable operation of the torch.

### SUMMARY OF THE INVENTION

The present disclosure is directed towards acquiring a vibration profile of a consumable assembly of a welding/cutting torch and determining a type of the consumable assembly based on the vibration profile. These techniques may be embodied as non-transitory computer readable storage media, one or more methods, and/or a system.

In accordance with at least one embodiment, the present application is directed to a non-transitory computer-readable medium, which includes instructions that, when executed by a processor, are configured to cause the processor to perform operations that include determining a plurality of properties of a vibration signal resulting from a gas flow being directed through a consumable assembly of a torch system over a period of time, generating a vibration profile of the consumable assembly based on the plurality of properties, and determining a type of the consumable assembly based on the vibration profile. One or more parameters of the gas flow directed through the consumable assembly are adjusted over the period of time to cause the vibration signal to have the plurality of properties.

In accordance with at least another embodiment, the present application is directed to a system, which includes a consumable assembly of a torch, the consumable assembly being configured to receive a gas flow directed therethrough. The system also has one or more processors configured to perform operations that includes generating a vibration profile of the consumable assembly based on a vibration signal resulting from the gas flow being directed through the consumable assembly and determining a type of the consumable assembly based on the vibration profile. The vibration profile includes a plurality of properties of the vibration signal generated by adjusting a parameter of the gas flow.

In accordance with at least one other embodiment, the present application is directed to a method, which includes determining a plurality of properties of a vibration signal generated from a gas flow directed through a consumable assembly of a torch and determining a type of the consumable assembly based on the plurality of properties of the vibration signal. A parameter of the gas flow directed through the consumable assembly is adjusted over a period of time to provide the plurality of properties of the vibration signal.

Other systems, methods, features and advantages will be, or will become, apparent to one with skill in the art upon examination of the following figures and detailed description. All such additional systems, methods, features and advantages are included within this description, are within the scope of the claimed subject matter.

### BRIEF DESCRIPTION OF THE DRAWINGS

The techniques presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts/steps throughout the different views.

FIG. 1A is a perspective view of an automated cutting system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch.

FIG. 2 illustrates a cross-sectional view of a consumable assembly utilized by the automated cutting system illustrated in FIGS. 1A and 1B, according to an example embodiment of the present disclosure.

FIG. 3 illustrates a schematic diagram of a vibration analysis system configured to determine a type of consumable assembly, according to an example embodiment of the present disclosure.

FIG. 4 illustrates a flowchart of a method to determine a type of consumable assembly based on a vibration profile, according to an example embodiment of the present disclosure.

FIG. 5 is a schematic diagram of a vibration analysis computing device configured to determine a type of consumable assembly, according to an example embodiment of the present disclosure.

FIG. 6 is a graph showing variations in plasma torch operational parameters over time, according to an example embodiment of the present disclosure.

FIG. 7 illustrates a hardware block diagram of a computing device that may execute the techniques presented herein.

### DETAILED DESCRIPTION OF THE INVENTION

The following description is not to be taken in a limiting sense but is given solely for the purpose of describing the broad principles of the present application. Embodiments of the present application will be described by way of example, with reference to the above-mentioned drawings showing elements and results of such embodiments.

The present disclosure is directed to a determining a type of a consumable assembly of a welding/plasma torch. For example, a gas flow is directed through the consumable assembly to produce a resulting vibration signal. A parameter of the gas flow, such as a pressure and/or a flow rate, is adjusted, and a property of the resulting vibration signal is monitored at the different parameters of the gas flow. The property (e.g., change in the property at the different gas flow parameters) of the vibration signal is used to generate a vibration profile. The vibration profile is then used to determine a type of the consumable assembly. For example, different types of consumable assemblies include different features that affect the vibration signal resulting from the gas flow through the consumable assembly. Thus, each type of consumable assembly may be associated with a unique vibration profile. The type of the consumable assembly may therefore be determined based on a determined vibration profile generated as a result of gas flow through the consumable assembly.

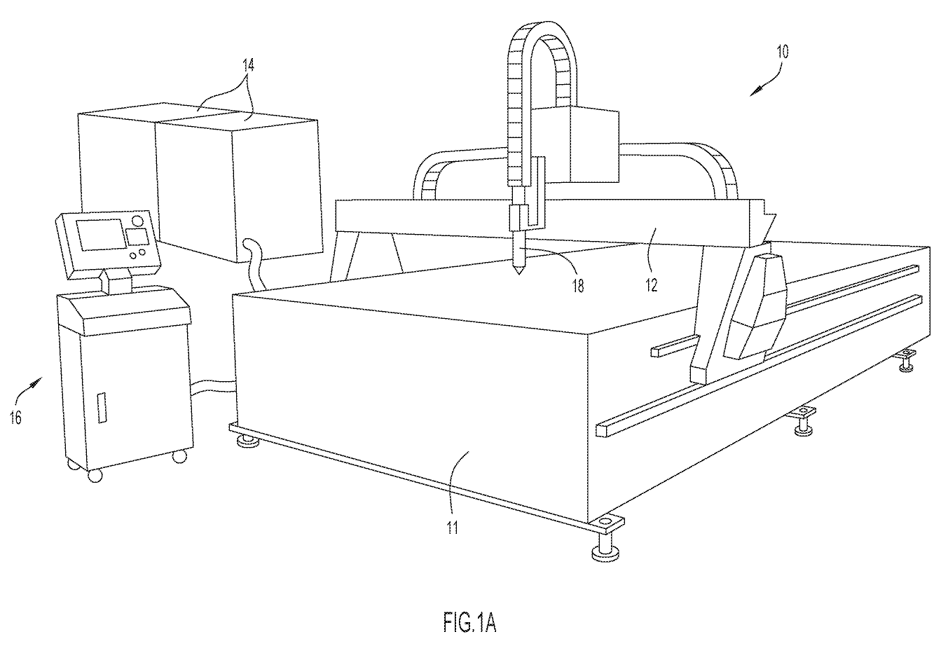

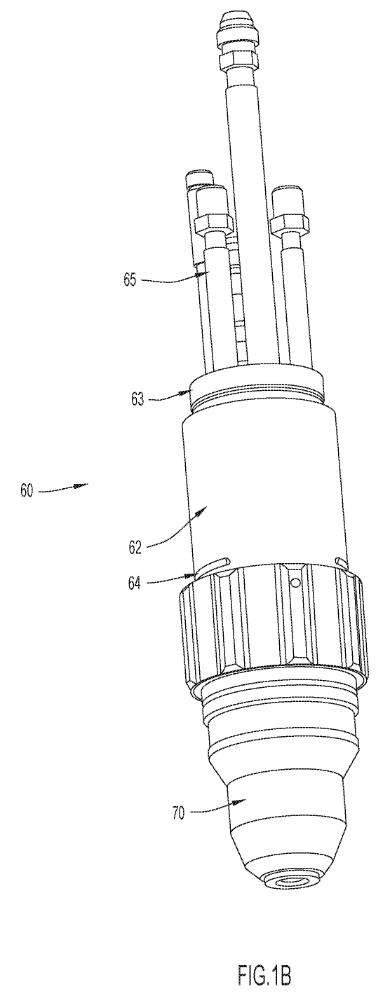

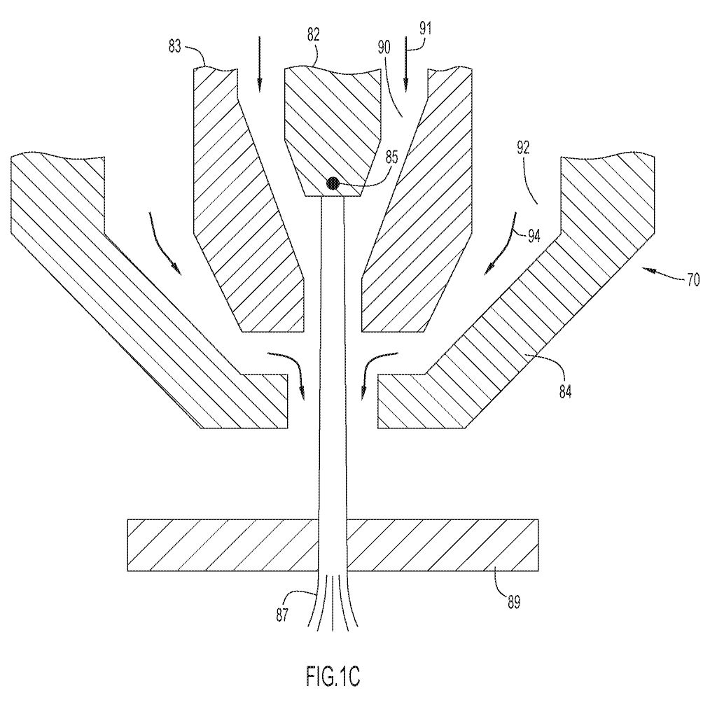

FIG. 1A illustrates an example embodiment of an automated torch system 10 (e.g., an automated cutting system) that may execute the techniques presented herein. However, this automated torch system 10 is merely presented by way of example, and the techniques presented herein may also be executed by manual cutting systems and/or automated cutting systems that differ from the automated torch system 10 of FIG. 1A (e.g., any robotic or partially robotic cutting system). That is, the torch system 10 illustrated in FIG. 1A is provided for illustrative purposes.

At a high-level, the automated torch system 10 includes a table 11 configured to receive a workpiece (not shown), such as, but not limited to, sheets of metal. The automated cutting system also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Finally, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14.

In at least some embodiments, the one or more power supplies 14 meter one or more flows of fluid received from one or more fluid supplies before or as the one or more power supplies 14 supply gas to the torch 18 via one or more cable conduits. Additionally or alternatively, the automated torch system 10 may include a separate fluid supply unit (not shown) or units that can provide one or more fluids to the automated torch 18 independent of the one or more power supplies 14. To be clear, as used herein, the term “fluid” shall be construed to include a gas, a liquid, and/or a mixture thereof. The one or more power supplies 14 may also condition, meter, and supply power to the automated torch 18 via one or more cables, which may be integrated with, bundled with, or provided separately from cable conduits for fluid flows. Additional cables for data, signals, and the like may also interconnect the controller 16, the automated plasma arc torch 18, the power supply 14, and/or the positioning system 12. Any cable or cable conduit/hose included in the automated torch system 10 may be any length. Moreover, each end of any cable or cable conduit/hose may be connected to components of the automated torch system 10 via any connectors now known or developed hereafter (e.g., via releasable connectors).

FIG. 1B illustrates an example embodiment of a cutting head 60 that may be used with a cutting system (e.g., the automated torch system 10 of FIG. 1A, a manual torch/cutting system) executing the techniques presented herein. As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the cutting head 60 to a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 to connect to the torch body 62 in detail. However, it should be understood that the cutting consumables, such as those schematically illustrated in FIG. 1C, may be coupled to a torch body 62 in any manner. Moreover, to be clear, the consumable stack/assembly 70 depicted in FIGS. 1B and 1C (with an external perspective view and a schematic cross-sectional illustration, respectively) is merely representative of a consumable stack that may be used with an automated torch executing the techniques presented herein. Similarly, while none of the Figures of the present application illustrate an interior of torch body 62, it is to be understood that any unillustrated components that are typically included in a torch, such as components that facilitate cutting operations, may (and, in fact, should) be included in a torch executing example embodiments of the present application.

Now turning to FIG. 1C, this Figure is a simplified/schematic illustration of the consumable stack 70 of FIG. 1B. As mentioned, FIG. 1C only illustrates select components or parts that allow for a clear and concise illustration of the techniques presented herein. Thus, in FIG. 1C, only an electrode 82, a nozzle 83, and a shield cap 84 of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The torch nozzle 83 is generally positioned around the electrode 82. In some embodiments, the nozzle 83 is installed after the electrode 82. Alternatively, the electrode 82 and nozzle 83 can be installed onto the torch body as a single component (e.g., these components may be coupled to each other to form a cartridge and installed on/in the torch body as a cartridge). In either case, the nozzle 83 may be spaced from the electrode 82; or, at least a distal portion of the nozzle 83 may be spaced apart from the distal portion of the electrode 82.

The shield 84 is positioned radially exteriorly of the nozzle 83 and is spaced apart from the nozzle, at least at its distal end. In some embodiments, the shield 84 is installed around an installation flange of the nozzle 83 in order to secure nozzle 83 and electrode 82 in place at (and in axial alignment with) an operating end of the torch body. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap, etc.) may be assembled together in a cartridge that may be selectively coupled to the torch body, e.g., by coupling the various components to a cartridge body or by coupling the various components to each other to form a cartridge.

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 flows through the plasma gas flow channel 90. The shield 84 is also spaced a distance away from the nozzle 83 so that a shield flow channel 92 is disposed between the shield 84 and the nozzle 83, A shield fluid 94 flows through the shield flow channel 92 during at least a portion of the time the torch is operated.

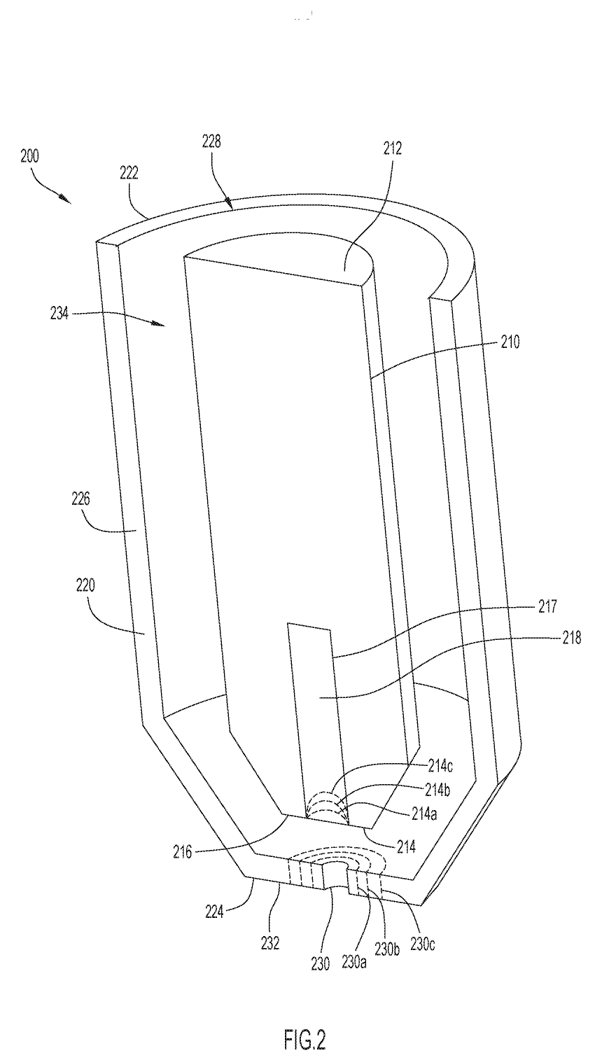

FIG. 2 illustrates a cross-sectional view of at least a portion of a consumable assembly 200, which can be a part of any suitable torch system (e.g., the automated torch system 10, a manual torch). The consumable assembly 200 includes an electrode 210 and a nozzle 220. The electrode 210 is elongated with a first or proximal electrode end 212 and an opposite second or distal electrode end 214. The second electrode end 214 includes an end face 216 with a cavity 217, within which an emissive insert 218 may be disposed. The nozzle 220 includes a first or proximal nozzle end 222 and an opposite second or distal nozzle end 224. The nozzle 220 further includes a sidewall 226 that extends from the first nozzle end 222 to the second nozzle end 224. As illustrated, a first opening 228 (e.g., a first nozzle opening) is disposed within the first nozzle end 222 of the nozzle 220, while a second nozzle opening or orifice 230 is disposed within an end face 232 of the second nozzle end 224 of the nozzle 220. The first nozzle end 222, the second nozzle end 224, and the sidewall 226 may collectively define an interior volume or interior cavity 234. As illustrated in FIG. 2, the electrode 210 is at least partially disposed within the interior cavity 234 such that the emissive insert 218 is disposed proximate to, and axially aligned with, the nozzle opening 230 of the nozzle 220.

The consumable assembly 200 is configured to couple to a torch body of a torch to enable the torch to direct gas to the consumable assembly 200 during operation of the torch. For example, the torch body is configured to discharge the gas into the interior cavity 234 and toward the second nozzle opening 230. At least for plasma cutting, discharge of the gas through the second nozzle opening 230 facilitates formation of an arc between the consumable assembly 200 and a metal workpiece to perform the processing operation on the metal workpiece.

Different types or embodiments of the consumable assembly 200 may be implemented in the torch and coupled to the torch body. That is, the torch body may be configured to couple to different types of consumable assemblies 200 to perform different processing operations, such as different types of cutting or welding operations based on a desired modification of the metal workpiece. In some embodiments, different types of consumable assemblies 200 may have dissimilar features, such as differently sized and/or shaped end faces 216, emissive inserts 218, and/or second nozzle openings 230. A series of different second electrode end profiles 214a, 214b, 214c of the end face 216 of the electrode 210 are shown in phantom lines. The second electrode end profiles 214a, 214b, 214c represent other possible configurations (e.g., contours) of the end face 216 of the electrode 210 for different types of the consumable assembly 200. Additionally, a series of different second nozzle opening profiles 230a, 230b, 230c of the nozzle 220 are shown in phantom lines. The second nozzle opening profiles 230a, 230b, 230c represent other possible configurations (e.g., opening sizes) of the second nozzle opening 230. These nozzle and electrode profiles might also be representative of wear.

However, to be clear, the profiles illustrated in FIG. 2 illustrate example geometric configurations, and different types of consumable assemblies 200 may include additional or alternative physical features that are different from one another. For example, different embodiments may include various surface formations (e.g., bumps, etchings, knurls, holes, cutouts, ribs, milled portions, engravements, embossments), different electrode dimensions (e.g., widths, lengths), different sizes of the interior cavity 234, and so forth. Moreover, different consumable assemblies may include different consumables, either in addition to or instead of the consumables generally illustrated in FIG. 2. For example, welding consumables might comprise a contact tip and distributor, plasma consumables might comprise a shield, shield cap, distributor, spring, etc., and these various consumables may create any desirable gas paths – e.g., flowing in any direction, through any desirable holes, cuts, ridges, etc. Still further, some consumable assemblies 200 might have more than one gas path that are isolated from one or more other gas paths, and any of these gas paths might be utilized to execute the techniques presented herein.

Now, regardless of the consumable properties, gas flow through a gas path in the consumable assembly 200 may produce vibration signals. As referred to herein, a vibration signal includes an oscillation of a material, such as a fluidic and/or solid material, which is effectuated by the gas flow. For example, impingement of the gas flow against a part (e.g., a surface formation) of the consumable assembly 200 and/or a change in direction (e.g., a change or pattern in turbulence) of the gas flow may vibrate (e.g., move, excite) energy in a material medium (e.g., air) and/or different parts of the consumable assembly 200. The resulting vibration signals may include audible acoustic signals (e.g., audible sound waves), inaudible acoustic signals (e.g., inaudible sound waves), an inertial signal (e.g., physical movement of the consumable assembly 200), or any combination thereof. The physical differences, such as surface formations, of the types of consumable assemblies 200 may cause gas to flow through different gas paths of consumable assemblies 200 in different manners, such as in different directions and/or at different speeds. The change in gas flow among different types of consumable assemblies 200 (or even from gas path to gas path in a consumable assembly 200) may adjust the resulting vibration signal being generated for the respective consumable assemblies 200. Consequently, each different consumable assembly may generate a unique vibration signal, and the particular vibration signal resulting from gas flow through the consumable assembly 200 may be used to determine the type or other identity of the consumable assembly 200.

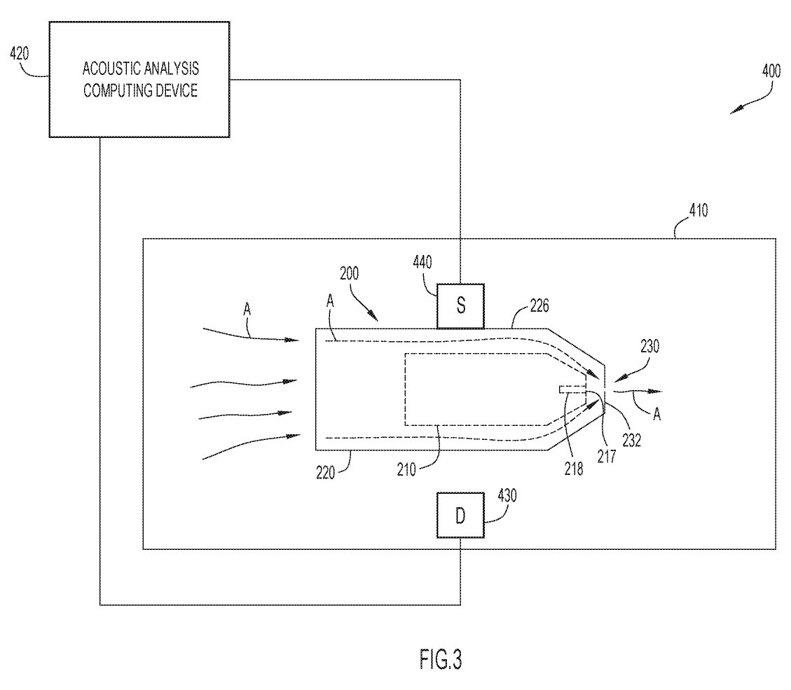

FIG. 3 is a schematic diagram of an embodiment of a vibration analysis system 400. The vibration analysis system 400 includes a testing environment 410 and a vibration analysis computing device 420. The vibration analysis computing device 420 is configured to determine a type of a consumable assembly 200 or an entire torch (with the consumable assembly 200) at the testing environment 410. The vibration analysis system 400 further includes sensor 440 communicatively coupled to the vibration analysis computing device 420. In some embodiments, the sensor 440 is positioned within the torch and/or in the consumable assembly 200, such as embedded in a wall and positioned without invasively affecting operation of the torch to direct and utilize gas flow. In additional or alternative embodiments, the sensor 440 is positioned external of the consumable assembly 200. The sensor 440 may include a microphone (e.g., a condenser microphone) configured to capture acoustic (e.g., audible acoustic, inaudible acoustic) signals, a movement sensor (e.g., an inertial measurement unit), a position sensor (e.g., a laser measurement device) configured to monitor inertial/physical vibration signals, and/or any other suitable sensor configured to determine vibration signals.

By way of example, during operation of the torch, a gas flow A is directed into the consumable assembly 200 (e.g., from the torch body). The gas flow A may flow through the consumable assembly 200, such as along the sidewall 226, around the electrode 210, and through the second nozzle opening 230. A vibration signal (e.g., sound, physical motion) may be generated by the gas flow A directed through the consumable assembly 200, and the vibration signal is detectable by the sensor 440. The sensor 440 is configured to receive or interpret the vibration signal and determine properties of the vibration signal, such as a frequency (e.g., pitch), an amplitude (e.g., loudness, intensity), spectral characteristics, patterns in time or in space, and so forth.

As discussed herein, different vibration signals may be generated by the gas flow A through different types of consumable assemblies 200. Thus, vibration signals produced by the gas flow A through different types of consumable assemblies 200 may have different properties. As an example, even though the gas flow A may generally flow through each consumable assembly 200 along the sidewall 226 toward the second nozzle opening 230, the gas flow A may flow at different speeds, in different directions, and/or contact different subcomponents when flowing through various consumable assemblies 200.

As an example, each consumable assembly 200 may include different physical features or surface formations. In certain embodiments, the physical features are machined onto a component of the consumable assembly 200, such as via a milling/etching/embossing/engraving process (e.g., to create varying depths within the consumable assembly 200). In additional or alternative embodiments, the physical features are provided by a particular positioning/dimension of components of the consumable assembly 200 (e.g., to provide a particular gas flow path). In either case, the arrangement of the physical features may adjust the gas flow A directed through the consumable assembly 200.

The different flows of the gas flow A may generate different vibration signals. The vibration analysis computing device 420 is configured to determine a particular type of consumable assembly 200 based on the property of a resulting vibration signal generated by the gas flow A directed through the consumable assembly 200. For example, the sensor 440 is configured to determine a property of the vibration signal and transmit data indicative of the property to the vibration analysis computing device 420. Then, the vibration analysis computing device 420 can compare the property to reference properties (e.g., a reference value) associated with respective types of consumable assemblies 200 and determine a particular type of the consumable assembly 200 based on the determined property of the vibration signal matching the reference property associated with the particular type of the consumable assembly 200.

In some embodiments, a vibration profile of the consumable assembly 200 is provided by varying the gas flow A through the consumable assembly 200 to enable further distinction between different types of consumable assemblies 200. For example, a parameter, such as an initial flow rate and/or an initial flow direction, of the gas flow A directed into and/or through the consumable assembly 200 is varied (e.g., via a control signal output by the vibration analysis computing device 420) in an attempt to create a specific response. In one example, the variations sweep in a linear fashion between a range or spectrum of values (e.g., by changing or alternating the pressure of the gas flow A between 0 pounds per pascals (Pa) or square inch (psi) to 551581 Pa or 80 psi), and vibration properties at the different gas flows A are determined. Additionally or alternatively, the variations may alter properties of the gas flow to try to create a certain collection of vibration signals, such as a song, a note, a chord (e.g., by simultaneously passing gas through multiple gas paths of a consumable assembly at specific properties), a movement path, a series of notes/chords/movements, etc. In any case, the vibration profile is generated based on the corresponding set of vibration properties associated with different parameters of the gas flow A. By changing the gas flow A through the consumable assembly 200, the corresponding vibration properties resulting from the changed gas flow A may be more unique and used to more clearly differentiate the various types of consumable assemblies 200 from one another.

The determined type of consumable assembly 200 may enable the torch to operate more effectively and/or efficiently. For example, operational settings or parameters related to the torch may be established based on the type of consumable assembly 200. In some embodiments, the settings may be established automatically. For instance, the vibration analysis computing device 420 may output a control signal that automatically adjusts the settings based on the determined type of consumable assembly 200. In additional or alternative embodiments, the vibration analysis may determine whether the consumable assembly 200 is or includes genuine components (e.g., components produced by the manufacturer of the welding or cutting systems). Such identification might help prevent a user from using consumables of lesser quality and/or that are otherwise incompatible, which might affect a structural integrity and/or reduce performance of the torch.

Still further, the vibration analysis computing device 420 may output a signal that informs a user (e.g., an operator) of the type of consumable assembly 200, such as by providing a visual output (e.g., on a display), providing an audio output, providing a tactile output (e.g., a vibration, a temperature change), and/or providing a notification that indicates the type of consumable assembly 200. The user may then be prompted to adjust the settings based on the type of consumable assembly 200 indicated by the vibration analysis computing device 420.

In certain embodiments, the vibration analysis computing device 420 may operate to determine the type of the consumable assembly 200 prior to performance of a processing operation by the torch. For example, the gas flow A may include a purge gas that is intended to remove latent fluid within the torch (e.g., within a cable hose, within a torch lead, within a torch body), such as after a change in the consumable assembly 200 and/or in the processing operation of the torch to prepare for operation of the torch after the change. Additionally or alternatively, the vibration analysis computing device 420 may operate to determine the type of the consumable assembly 200 during the performance of a processing operation by the torch. As an example, the gas flow A may be used to perform a cutting and/or welding operation (e.g., by forming a plasma arc), in addition to generating vibration signals. Thus, the type of consumable assembly 200 may be determined during operation of the torch. In further embodiments, the vibration analysis computing device 420 may operate to determine the type of the consumable assembly 200 after performance of the processing operation by the torch has been suspended. For instance, the consumable assembly 200 is replaced after the processing operation by the torch is terminated, and the vibration analysis computing device 420 may determine the type of the replacement consumable assembly 200 prior to initiating a subsequent processing operation by the torch.

In additional or alternative embodiments, a vibration profile for the consumable assembly 200 may be generated using a different technique. By way of example, the vibration analysis system 400 includes a signal output generating device 430 communicatively coupled to the vibration analysis computing device 420. The signal output generating device 430 may be any type of signal emitter, such as a speaker or audio output generating device configured to generate any type of acoustical output (e.g., audible outputs, inaudible outputs) and/or a vibration output generating device configured to generate an inertial vibration, that is configured to output a signal for conduction through the consumable assembly 200. Conduction of the signal through the consumable assembly 200 may result in the vibration signal that is detectable by the sensor 440. For example, the physical features of the consumable assembly 200 may adjust a property (e.g., a pitch) of the signal output by the signal output generating device 430 to provide the vibration signal. Thus, the property of the vibration signal detected by the sensor 440 may be different from a property of the signal initially output transmitted by the vibration analysis computing device 420.

Indeed, the manner in which the signal output is adjusted may be based on the physical features of the consumable assembly 200. Thus, different types of consumable assemblies 200 having dissimilar physical features may provide different vibration signals that are detected by the sensor 440. In this manner, the vibration analysis computing device 420 may be configured to determine the type of consumable assembly 200 based on the vibration signal detected by the sensor 440 as a result of the signal output of the signal output generating device 430. For example, a vibration profile of the consumable assembly 200 may be generated by varying a parameter of the signal output of the signal output generating device 430 and determining the property of the resulting vibration signals received by the sensor 440 and associated with the varied signal output.

That all said, the signal output generating device 430 need not be included in the testing environment 410. In fact, in at least some embodiments, the techniques presented herein can be executed without a testing environment 410. Or, from a different perspective, the testing environment 410 may be an open air space at a work site (e.g., above a workpiece), and the techniques presented herein may be executed prior to a cutting or welding operation in a location most convenient for the user.

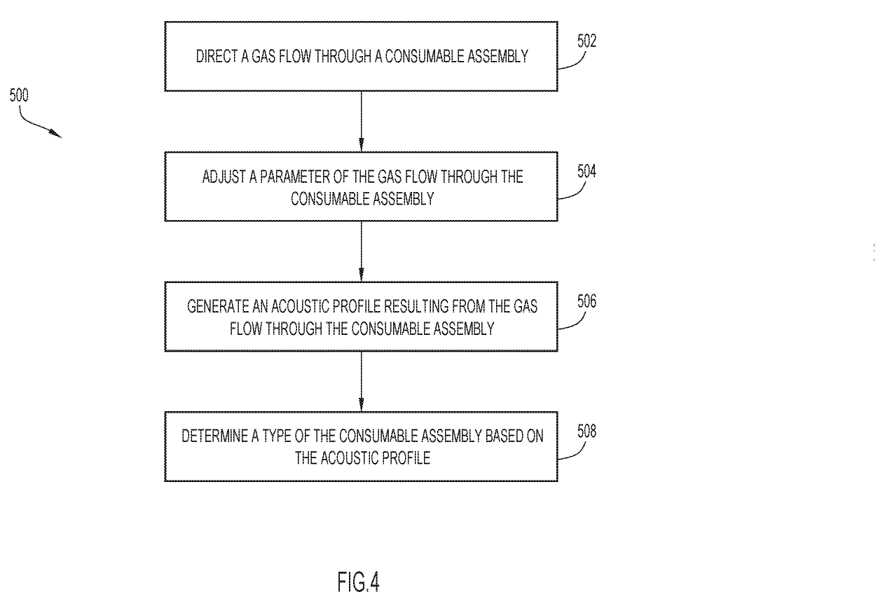

FIG. 4 is a flowchart of an example method 500 for determining a type of consumable assembly based on a vibration profile. In some embodiments, operations of the method 500 may be performed by a single component, such as the vibration analysis computing device 420. In additional or alternative embodiments, different operations of the method 500 may be performed by different components. It should also be noted that the method 500 may be performed differently than depicted in FIG. 4. For example, an additional operation may be performed, and/or an operation of the method 500 may be removed, performed differently, and/or in a different order.

At block 502, a gas flow is directed through the consumable assembly 200 of a torch. For example, a power supply may operate to direct the gas flow from a gas supply to the torch, which discharges the gas flow to the consumable assembly 200. The gas flow through the consumable assembly 200 may result in a vibration signal. For instance, different physical features of the consumable assembly 200, such as etchings having a particular depth/height, may adjust the flow (e.g., a flow velocity, a flow direction) of the gas flow to cause a vibration signal to be generated. Indeed, different types of consumable assemblies 200 may have different physical features, such as physical features that indicate the manufacturer of the consumable assembly 200, to generate different vibration signals.

At block 504, a parameter of the gas flow directed into/through the consumable assembly 200 is adjusted. Adjusting the parameter of the gas flow changes the vibration signal being generated, and different consumable assemblies 200 may adjust the manner in which the vibration signal changes (e.g., based on the physical features of the consumable assembly 200). Such a parameter may include a pressure, velocity, and/or direction of the gas flow. In one example, the pressure may linearly sweep or alternate between a low threshold value and a high threshold value.

At block 506, a vibration profile resulting from the gas flowing through the consumable assembly 200 is generated. The vibration profile includes properties of the vibration signal generated by the gas flow directed through the consumable assembly 200 at the different parameters. At block 508, a type of the consumable assembly 200 is determined based on the vibration profile. By way of example, the vibration profile may be compared to a set of reference or expected vibration profiles that are associated with respective, corresponding types of consumable assemblies 200. The type of the consumable assembly 200 is determined based on its associated vibration profile matching that of the generated vibration profile (e.g., a difference between the generated vibration profile and the associated vibration profile is below a threshold or within acceptable value bounds). In some instances, the “type” indicates the manufacturer of the consumable assembly 200 (i.e., whether a consumable assembly 200 or portions thereof are genuine). In other instances, the “type” identifies a process and/or process parameters for which the consumable assembly 200 is intended, such as 60 amp cutting, gouging, 600 amp cutting, etc.

In certain embodiments, operation of the torch is adjusted based on the determined type of the consumable assembly 200. For example, an operational parameter is set based on the type of the consumable assembly 200, such as to facilitate desirable operating conditions for the consumable assembly 200. Operation of the torch may also be suspended or blocked as a result of performance of the method 500. For instance, the type of the consumable assembly 200 may be determined to be incompatible and/or unrecognizable. In additional or alternative embodiments, a visual output, an audio output, a tactile output, or a notification may be provided to indicate the type of the consumable assembly 200.

Additionally, a technique similar to the method 500 may be performed to determine the type of the consumable assembly 200 based on a signal output provided to the consumable assembly 200. For example, a signal output with a varied parameter is conducted through the consumable assembly, and a vibration profile is generated based on the properties of a vibration signal produced as a result of the signal output conducted through the consumable assembly 200. The type of the consumable assembly 200 is then determined based on the vibration profile.

Furthermore, multiple gas flows (e.g., plasma gas, shield gas) may be directed through the consumable assembly 200 to produce the vibration signals used for determining the type of the consumable assembly 200. The parameters of each gas flow may be adjusted relative to one another to generate the acoustic profile. As an example, both gas flows (e.g., respective pressures of the gas flows) may be linearly ramped up. As another example, one of the gas flows (e.g., plasma gas) is ramped up while the other of the gas flows (e.g., shield gas) is linearly ramped down. Thus, the gas flows can be acutely controlled to produce more specific vibration signals to generate a particular acoustic profile that can be more easily discernible for identifying the type of the consumable assembly 200 (e.g., from other types of the consumable assembly 200).

The method 500 is performed prior to performing a cutting/welding operation of the torch in some embodiments. Thus, an operational parameter of the cutting/welding operation can be established to facilitate desirable performance upon initiating the cutting/welding operation. In additional or alternative embodiments, the method 500 is performed during the cutting/welding operation, such as to confirm the type of the consumable assembly 200. In further embodiments, the method 500 is performed after the cutting/welding operation has been suspended, such as to prepare for initiating a subsequent cutting/welding operation.

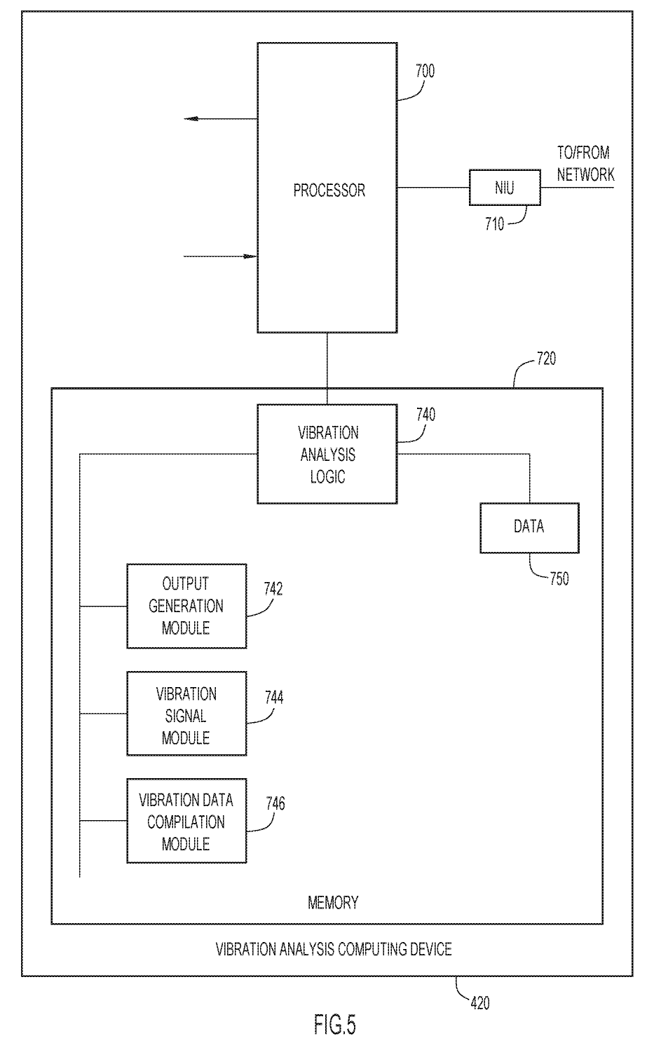

FIG. 5 illustrates an example schematic diagram of the vibration analysis computing device 420 of the vibration analysis system 400 configured to perform the techniques for determining a type of the consumable assembly 200 in accordance with the embodiments described herein. The vibration analysis computing device 420 includes a processor 700, a network interface (I/F) unit (NIU) 710, and memory 720. The NIU is, for example, an Ethernet card or other interface device that allows the vibration analysis computing device 420 to communicate over a communication network. The network I/F unit 710 includes wired and/or wireless connection capability.

Processor 700 includes a collection of microcontrollers and/or microprocessors, for example, each microcontroller/microprocessor is configured to execute respective software instructions stored in the memory 720. The collection of microcontrollers includes, for example: a display controller to receive, send, and process display signals related to a display connected to the vibration analysis computing device 420; an audio processor to receive, send, and process vibration signals related to the signal output generating devices 430 and the sensor 440; and a high-level controller to provide overall control. Portions of memory 720 (and the instructions therein) may be integrated with processor 700.

The memory 720 includes read only memory (ROM), random access memory (RAM), magnetic disk storage media devices, optical storage media devices, flash memory devices, electrical, optical, and/or other physical/tangible (e.g., non-transitory) memory storage devices. Thus, in general, the memory 720 includes one or more computer readable storage media (e.g., a memory device) encoded with software with computer executable instructions that may be executed to effectuate the operations described herein. For example, the memory 720 stores or is encoded with instructions for vibration analysis logic 740 that facilitate determining a type of consumable assembly 200 based on a vibration profile. The vibration analysis logic 740 includes an output generation module 742 configured to cause a gas flow directed into/through the consumable assembly 200 and/or a vibration output provided by the signal output generating device 430 to vary. The vibration analysis logic 740 also includes a vibration signal module 744 configured to determine a property of the vibration signal determined by the sensor 440 and resulting from the gas flow through the consumable assembly 200 and/or the signal output directed through the consumable assembly 200. The vibration analysis logic 740 further includes a vibration data compilation module 746 configured to enable the vibration analysis computing device 420 to compile the detected properties of the vibration signal (e.g., resulting from adjusted gas flows directed into/through the consumable assembly 200) to generate a vibration profile. In addition, the memory 720 stores data 750 used and generated by logic/modules 740-748, including, but not limited to: reference vibration profiles associated with respective types of consumable assemblies 200, settings of the torch associated with respective types of consumable assemblies 200, and/or property adjustments of gas/signal to be directed through the consumable assembly 200 for generating vibration profiles.

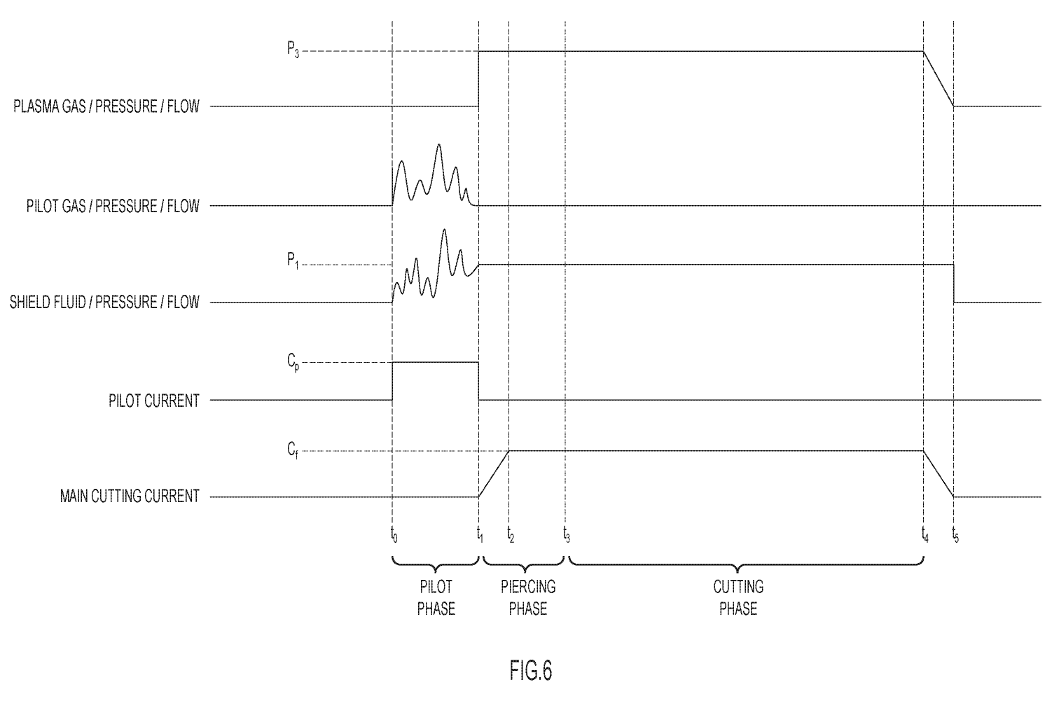

FIG. 6 depicts a timeline showing how pilot current, main cutting current, pilot gas, plasma gas, and shield fluid are supplied to a plasma torch during a plasma torch cutting operation. In this embodiment, during initiation at time t₀, which can be considered a “pilot phase” of the plasma torch cutting operation, a high voltage and high frequency signal is applied as pilot current Cₚ (e.g., approximately 10 Amps to approximately 50 Amps) between the electrode 210 and the nozzle 220. This high voltage and high frequency signal produces a pilot arc between the electrode 210 and the nozzle 220 that extends across the plasma gas flow passage through which pilot gas is supplied. Pilot gas is also directed through the plasma gas flow passage at t₀, and the pilot gas is ionized to form an electrically conductive plasma arc that is then directed out the nozzle 220 toward an electrically conductive workpiece (e.g. metal workpiece). Furthermore, a shield fluid is directed through a shield flow channel at t₀ to protect the pilot arc from contaminants.

The pilot gas and/or the shield fluid may be used to generate a vibration profile. For example, a vibration signal resulting from flow of the pilot gas and/or shield fluid through the consumable assembly 200 is received, and a parameter of the pilot gas and/or of the shield fluid may be varied during the pilot phase to produce a vibration signal having different properties. Such properties are compiled to generate the vibration profile. The vibration profile may then be analyzed to determine a type of the consumable assembly 200. As an example, the vibration profile may be used to determine a type of the consumable assembly 200 for establishing an operational parameter and operating the torch according to the operational parameter.

When the pilot arc transfers to the workpiece at time t₁, the torch transitions from a pilot phase to a piercing phase. For instance, based on the determined type of the consumable assembly 200, additional operations of the torch may be effectuated. As an example, at time t₁, main cutting current is supplied to the electrode 210 and ramped up so that the main cutting current reaches a full cutting current C_{f} at time t₂ shortlyafter initiation of the piercing phase at time t₁. According to some implementations, the switching from pilot current Cₚ to full main cutting current C_{f} commences upon the power supply detecting a change in power characteristics (e.g., current or voltage) when the pilot arc is transferred to the workpiece. In any case, during the switching, the power supply disconnects from the nozzle 220, and the main cutting current is ramped up to full cutting current C_{f}. Once the current is ramped to the full cutting current C_{f,} the current remains at the full cutting current C_{f} until the piercing phase is completed at time t₃. In some implementations, the full cutting current C_{f} is approximately 150 Amps, but in other embodiments, the full cutting current C_{f} is less than approximately 150 Amps, between approximately 150 Amps and 500 Amps, or more than 500 Amps, such as in the range of approximately 600 to approximately 800 Amps, approximately 900 Amps (e.g., 890 Amps), or more. Indeed, the C_{f} may be established based on the type of the consumable assembly 200.

Additionally, when the torch transitions from the pilot phase to the piercing phase, plasma gas and shield fluid are provided to the torch and maintained at respective levels. For example, the shield fluid is provided at a pressure P₁ beginning at time t₁ to maintain a generated arc. Moreover, the pilot gas flow is blocked after t₁. Instead, after t₁, the plasma gas is provided through the plasma gas flow channel at a pressure P₃ to transfer a plasma arc from the nozzle 220 to the workpiece. During the piercing phase, this plasma gas is ionized so that the plasma arc extends to the workpiece to establish a closed electrical circuit including the electrode 210 and the workpiece that is sufficient to cut through the workpiece by a localized melting of the material from which the workpiece is made. The shield fluid provided at the pressure P₁ may sufficiently protect and maintain the plasma arc. Each of the pressures P₁ and P₃ may be established based on the type of the consumable assembly 200. Notably, although FIG. 6 shows the pilot gas switching off at time t₁ as the supply of plasma gas is initiated, in many implementations, the pilot gas and the plasma gas are the same. In such instances, the switching from pilot gas to plasma gas may only involve changing the gas pressure. The piercing phase ends (at time t₃) when the workpiece has been fully penetrated by the plasma stream.

In the depicted scheme, the plasma gas is maintained at the pressure P₃ for the piercing phase (e.g., from time t₁ to time t₃₎ and the subsequent cutting phase (e.g., from time t₃ to time t₄). Likewise, the shield fluid is maintained at the pressure P₁ for the piercing phase (e.g., from time t₁ to time t₃₎ and the subsequent cutting phase (e.g., from time t₃ to time t₄). Thus, each of the plasma gas pressure and shield fluid pressure remains constant during the piercing phase between time t₁-t₃ (when a pierce hole is formed through the workpiece) and the cutting phase between time t₃-t₄ (when the workpiece is cut to form a desired work product). According to one standard operating procedure, the pressure of the plasma gas is maintained at around 60 psi and the pressure of the shield fluid is maintained at about 80 psi during the piercing and cutting phases. Then, after termination of the cutting phase at time t₄, during which cutting of the workpiece is suspended, the pressure of the plasma gas and the pressure of the shield fluid are ramped down to or near 0 psi at time t₄-t₅ to suspend arc generation. During this ramp down period (e.g., from time t₄-t₅), the cutting current is also ramped down to 0 amps, further blocking arc generation.

In some embodiments, such as upon determination that an incompatible or unrecognized consumable assembly 200 is being used, operation of the torch may be blocked at/after t₁. For example, after the type of the consumable assembly 200 is determined by using the vibration profile generated based on a vibration signal resulting from flow of the pilot gas and/or of the shield fluid, the pilot gas and the shield fluid may be shut off, and the plasma gas may not be initiated. Moreover, the pilot current Cₚ may be interrupted, and the main cutting current C_{f} may not be directed. As a result, further operation of the torch may be suspended after the pilot phase.

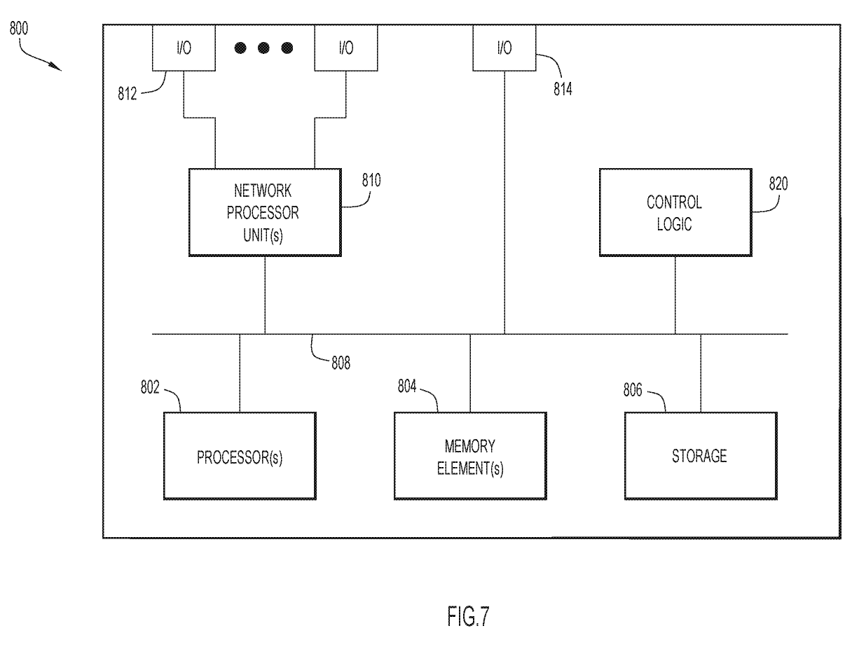

Now turning to FIG. 7, this Figure illustrates a hardware block diagram of a computing device 800 that may execute the techniques presented herein. This computing device 800 may be included in or formed from portions of any combination of parts included in the controller 16, the automated plasma arc torch 18, the power supply 14, the positioning system 12 of an automated torch system 10, and/or the vibration analysis computing device 420 of the vibration analysis system 400. Thus, any of the controller 16, the automated plasma arc torch 18, the power supply 14, the positioning system 12 of an automated torch system 10, and/or the vibration analysis computing device 420 of the vibration analysis system 400 may execute the techniques presented herein, alone or in combination with one or more other systems/components.

As depicted, the computing device 800 includes a bus 808, which provides communications between computer processor(s) 802, one or more memory elements 804, persistent storage or memory 806, one or more network processor units 810 (i.e., a communications unit), and input/output (I/O) interface(s) 814. The bus 808 can be implemented with any architecture designed for passing data and/or control information between processors (such as microprocessors, communications and network processors, etc.), system memory, peripheral devices, and any other hardware components within a system. For example, the bus 808 can be implemented with one or more buses.

Memory 806 and/or memory element 804 may include random access memory (RAM) or other dynamic storage devices (i.e., dynamic RAM (DRAM), static RAM (SRAM), and synchronous DRAM (SD RAM)), for storing information and instructions to be executed by processor 802. The memory 806 and/or memory element 804 may also include a read only memory (ROM) or other static storage device (i.e., programmable ROM (PROM), erasable PROM (EPROM), and electrically erasable PROM (EEPROM)) for storing static information and instructions for the processor 802. Additionally, although “control logic” 820 is illustrated separately from memory 806 and/or memory element 804, the control logic 820 may be stored as non-transitory computer readable instructions in memory 806 and/or memory element 804, for execution by processor 802 so that processor 802 can execute the techniques presented herein.

Although FIG. 7 shows the processor 802 as a single box, it should be understood that the processor 802 may represent a plurality of processing cores, each of which can perform separate processing. The processor 802 may also include special purpose logic devices (i.e., application specific integrated circuits (ASICs)) or configurable logic devices (i.e., simple programmable logic devices (SPLDs), complex programmable logic devices (CPLDs), and field programmable gate arrays (FPGAs)), that, in addition to microprocessors and digital signal processors may individually, or collectively, are types of processing circuitry.

The processor 802 performs a portion or all of the processing steps required to execute the techniques presented herein, e.g., in response to instructions received at network processor unit(s) 810 and/or instructions contained in memory element 804 and/or memory 806. Such instructions may be read into memory element 804 and/or memory 806 from another computer readable medium. One or more processors in a multi-processing arrangement may also be employed to execute the sequences of instructions contained in memory element 804 and/or memory 806. In alternative embodiments, hard-wired circuitry may be used in place of or in combination with software instructions. Thus, embodiments are not limited to any specific combination of hardware circuitry and software. Put another way, the computing device 800 includes at least one computer readable medium or memory for holding instructions programmed according to the embodiments presented, for containing data structures, tables, records, or other data described that might be required to execute the techniques presented herein.

Still referring to FIG. 7, the network processor unit(s) 810 provides a two-way data communication coupling to a network, such as a local area network (LAN) or the Internet. The two-way data communication coupling provided by the network processor unit(s) 810 can be wired (e.g., via I/O interface(s) 812) or wireless. Meanwhile, I/O interface(s) 814 may allow for input and output of data with other devices that may be connected to computing device 800. For example, I/O interface 814 may provide a connection to external devices such as a keyboard, keypad, a touch screen, and/or some other suitable input device. External devices can also include portable computer readable storage media such as database systems, thumb drives, portable optical or magnetic disks, and memory cards.

While the apparatuses and methods presented herein have been illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. For example, the vibration analysis apparatuses presented herein may be modified to contain any number of signal output generating devices, vibration capturing devices, vibration analysis computing devices, etc., and the vibration analysis computing devices may connect to any number of input and output devices, along with any number of networks and/or servers. Additionally, the methods presented herein may be suitable for any type of welding and/or cutting consumable assemblies, including consumable assemblies utilized for automated (e.g., mechanized) and/or manual (e.g., handheld) operations.

In addition, various features from one of the embodiments may be incorporated into another of the embodiments. That is, it is believed that the disclosure set forth above encompasses multiple distinct inventions with independent utility. While each of these inventions has been disclosed in a preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention. Additionally, it is also to be understood that the components of the apparatuses described herein, the consumable assemblies described herein, or portions thereof may be fabricated from any suitable material or combination of materials, such as plastic or metals (e.g., copper, bronze, hafnium, etc.), as well as derivatives thereof, and combinations thereof. In addition, it is further to be understood that the steps of the methods described herein may be performed in any order or in any suitable manner.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about”, “around”, “generally”, and “substantially.”

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. A non-transitory computer readable medium comprising instructions that, when executed by a processor, are configured to cause the processor to perform operations comprising:
determining a plurality of properties of a vibration signal resulting from a gas flow being directed through a consumable assembly of a torch system over a period of time, wherein one or more parameters of the gas flow directed through the consumable assembly are adjusted over the period of time to cause the vibration signal to have the plurality of properties;
generating a vibration profile of the consumable assembly based on the plurality of properties; and
determining a type of the consumable assembly based on the vibration profile.

2. The non-transitory computer readable medium of claim 1, wherein the instructions, when executed by the processor, are configured to cause the processor to determine the type of the consumable assembly based on the vibration profile by:
comparing the vibration profile of the consumable assembly to a plurality of reference vibration profiles, wherein each reference vibration profile of the plurality of reference vibration profiles is associated with a respective, corresponding type of the consumable assembly; and
determining the type of the consumable assembly based on the reference vibration profile associated with the type of the consumable assembly matching the vibration profile of the consumable assembly generated based on the plurality of properties.

3. The non-transitory computer readable medium of claim 1, wherein the instructions, when executed by the processor, are configured to cause the processor to set one or more additional parameters of the torch system based on the type of the consumable assembly.

4. The non-transitory computer readable medium of claims 1, wherein the instructions, when executed by the processor, are configured to cause the processor to adjust the one or more parameters of the gas flow directed through the consumable assembly over the period of time.

5. The non-transitory computer readable medium of claim 4, wherein the one or more parameters of the gas flow directed through the consumable assembly over the period of time comprise a pressure, a speed, a direction, or any combination thereof.

6. The non-transitory computer readable medium of claim 1, wherein the instructions, when executed by the processor, are configured to cause the processor to perform operations comprising:
determining installation of the consumable assembly into the torch system; and
determining the plurality of properties of the vibration signal resulting from the gas flow being directed through the consumable assembly over the period of time in response to determining the installation of the consumable assembly into the torch system.

7. The non-transitory computer readable medium of claim 1, wherein the instructions, when executed by the processor, are configured to cause the processor to perform operations comprising:
determining an additional plurality of properties of an additional vibration signal resulting from a vibration output signal being directed through the consumable assembly of the torch system over an additional period of time, wherein one or more additional parameters of the vibration output signal directed through the consumable assembly are adjusted over the additional period of time to cause the additional vibration signal to have the additional plurality of properties;
generating an additional vibration profile of the consumable assembly based on the additional plurality of properties; and
determining the type of the consumable assembly based on the additional vibration profile.

8. A system, comprising:
a consumable assembly of a torch, the consumable assembly being configured to receive a gas flow directed therethrough; and
one or more processors configured to perform operations comprising:
generating a vibration profile of the consumable assembly based on a vibration signal resulting from the gas flow being directed through the consumable assembly, wherein the vibration profile comprises a plurality of properties of the vibration signal generated by adjusting a parameter of the gas flow; and
determining a type of the consumable assembly based on the vibration profile.

9. The system of claim 8, wherein the consumable assembly comprises a surface formation configured to generate the vibration signal in response to impingement of gas flow against the surface formation.

10. The system of claim 9, wherein the surface formation comprises a bump, an etching, a knurl, a hole, a cutout, a rib, a milled portion, an engravement, an embossment, or any combination thereof.

11. The system of claim 8, comprising a sensor configured to detect the vibration signal, wherein the one or more processors are communicatively coupled to the sensor and are configured to generate the vibration profile based on the vibration signal detected by the sensor.

12. The system of claim 11, wherein the sensor is embedded in the torch.

13. A method, comprising:
determining a plurality of properties of a vibration signal generated from a gas flow directed through a consumable assembly of a torch, wherein a parameter of the gas flow directed through the consumable assembly is adjusted over a period of time to provide the plurality of properties of the vibration signal; and
determining a type of the consumable assembly based on the plurality of properties of the vibration signal.

14. The method of claim 13, comprising directing the gas flow through the consumable assembly.

15. The method of claim 14, comprising adjusting the parameter of the gas flow between a low threshold value and a high threshold value over the period of time.

16. The method of claim 14, comprising directing an additional gas flow through the consumable assembly to generate the vibration signal.

17. The method of claim 16, comprising increasing the parameter of the gas flow over the period of time and reducing an additional parameter of the additional gas flow over the period of time to provide the plurality of properties of the vibration signal.

18. The method of claim 16, wherein the gas flow comprises plasma gas that facilitates generation of a plasma arc, and the additional gas flow comprises shield gas that maintains the plasma arc.

19. The method of claim 13, comprising operating the torch to generate an arc via the gas flow after determining the type of the consumable assembly.

20. The method of claim 19, comprising establishing an operational parameter of the torch based on the type of the consumable assembly, wherein the torch is operated according to the operational parameter.
